(19) United States
(12) Patent Application Publication
(10) Pub. No.: US 2012/0019005 A1
(43) Pub. Date: Jan. 26, 2012

(54) INTERNAL COMBUSTION ENGINE WITH ROCKER MEMBER-AFFECTED STROKE

(76) Inventor: Larry C. WILKINS, Ft. Lauderdale, FL (US)

(21) Appl. No.: 13/187,947

(22) Filed: Jul. 21, 2011

Related U.S. Application Data
(60) Provisional application No. 61/367,162, filed on Jul. 23, 2010.

(51) Int. Cl. F02B 75/32; H02K 7/18

(52) U.S. Cl. 290/1 A; 123/197.3

(57) ABSTRACT

An internal combustion engine may include a cylinder block defining a cylinder and a crankshaft including a crankpin. The crankshaft is rotatably received by the cylinder block and rotates along a longitudinal axis, and the crankpin defines a longitudinal axis parallel to and spaced from the longitudinal axis along which the crankshaft rotates. The engine may further include a piston configured to reciprocate within the cylinder and a connecting rod including a distal end and a proximal end, wherein the distal end is operably coupled to the piston. The engine may also include a rocker member including a pivot portion, a coupling portion, and a slot, wherein the pivot portion is operably coupled to the cylinder block, the coupling portion is operably coupled to the proximal end of the connecting rod, and the slot is operably coupled to the crankpin. The slot may be configured to vary a distance between the crankpin and the distal end of the connecting rod.

### RELATED APPLICATION

This application claims the benefit of priority under 35 U.S.C. §119(e) of U.S. Provisional Application No. 61/367,162, filed Jul. 23, 2010, the disclosure of which is incorporated herein by reference.

### FIELD OF THE DISCLOSURE

The present disclosure relates to internal combustion engines. In particular, the present disclosure relates to internal combustion engines with improved fuel efficiency and/or power output.

### BACKGROUND

High fuel costs and a desire to reduce undesirable emissions associated with operation of internal combustion engines has renewed interest in improving fuel efficiency during operation. Thus, it may be desirable to improve the efficiency of conventional internal combustion engines.

A conventional internal combustion engine includes a cylinder block defining journals for receiving a crankshaft and one or more cylinders housing a piston that is operably coupled to the crankshaft at a crankpin via a connecting rod. During conventional operation, the piston reciprocates within the cylinder, such that during a power stroke of the internal combustion engine, combustion of an air/fuel mixture within a combustion chamber defined by the piston, the cylinder, and a cylinder head forces the piston toward the crankshaft. As the piston travels toward the crankshaft, the crankshaft is rotated via the connecting rod and crankpin, thereby converting the potential energy associated with the air/fuel mixture into mechanical work.

Due to the architecture of a conventional internal combustion engine, when the piston is at a position within the cylinder that coincides with the maximum compression (i.e., the combustion chamber is at its lowest volume when the piston is farthest from the crankshaft), the radial axis extending between the center of the crankshaft and the center of the crankpin tends to be nearly co-linear, if not co-linear, with the axis of the connecting rod. At these relative positions, as the piston first begins its movement toward the crankshaft during the power stroke, there is only a very short moment arm (if any) created between the axis connecting rod and the radial axis. As a result, the force initially created by the air/fuel mixture at the moment of combustion does not transfer as much torque to the crankshaft as it would if the length of the moment arm were greater. This situation may be particularly undesirable because during combustion and very shortly thereafter, the force on the piston due to the combustion event approaches its maximum magnitude. Further, as the piston travels down the cylinder toward the crankshaft and the length of the moment arm increases, the magnitude of the force from the combustion event acting on the piston dissipates rapidly. Thus, because there is a very short moment arm created between the axis of the connecting rod and the radial axis during the time of maximum force on the piston, efficiency of the work generated from the combustion process may be less than desired.

Thus, it may be desirable to provide an internal combustion engine with a configuration that improves the efficiency of the internal combustion engine during operation. Further, it may be desirable to provide an internal combustion engine with a configuration that permits tailoring of desired performance characteristics.

### SUMMARY

In the following description, certain aspects and embodiments will become evident. It should be understood that the aspects and embodiments, in their broadest sense, could be practiced without having one or more features of these aspects and embodiments. It should be understood that these aspects and embodiments are merely exemplary.

One aspect of the disclosure relates to an internal combustion engine. The internal combustion engine may include a cylinder block defining a cylinder and a crankshaft including a crankpin. The crankshaft is rotatably received by the cylinder block and rotates along a longitudinal axis, and the crankpin defines a longitudinal axis parallel to and spaced from the longitudinal axis along which the crankshaft rotates. The engine may further include a piston configured to reciprocate within the cylinder and a connecting rod including a distal end and a proximal end, wherein the distal end is operably coupled to the piston. The engine may also include a rocker member including a pivot portion, a coupling portion, and a slot, wherein the pivot portion is operably coupled to the cylinder block, the coupling portion is operably coupled to the proximal end of the connecting rod, and the slot is operably coupled to the crankpin. The slot may be configured to vary a distance between the longitudinal axis of the crankpin and the distal end of the connecting rod.

According to another aspect, an internal combustion engine may include a cylinder block defining a cylinder and a crankshaft including a crankpin. The crankshaft is rotatably received by the cylinder block and rotates along a longitudinal axis, and the crankpin defines a longitudinal axis parallel to and spaced from the longitudinal axis along which the crankshaft rotates. The engine may further include a piston configured to reciprocate within the cylinder and a connecting rod including a distal end and a proximal end, wherein the distal end is operably coupled to the piston. The engine may also include a rocker member including a pivot portion, a coupling portion, and a slot, wherein the pivot portion is operably coupled to the cylinder block, the coupling portion is operably coupled to the proximal end of the connecting rod, and the slot is operably coupled to the crankpin. The rocker member may be configured such that relative motion between the slot and the crankpin results in a distance between the longitudinal axis of the crankpin and an upper surface of the piston being variable.

According to still a further aspect, an internal combustion engine may include a cylinder block defining a cylinder and a crankshaft including a crankpin. The crankshaft is rotatably received by the cylinder block and rotates along a longitudinal axis, and the crankpin defines a longitudinal axis parallel to and offset by a distance with respect to the longitudinal axis along which the crankshaft rotates. The engine may further include a piston configured to reciprocate within the cylinder between spaced stroke termination points defining a stroke of the piston. The engine may also include a connecting rod including a distal end and a proximal end, wherein the distal end is operably coupled to the piston. The engine may further include a rocker member including a pivot portion, a coupling portion, and a slot, wherein the pivot portion is operably coupled to the cylinder block, the coupling portion is operably coupled to the proximal end of the connecting rod, and the slot is operably coupled to the crankpin. A line extending between the longitudinal axis along which the crankshaft rotates and the longitudinal axis of the crankpin defines a radial axis of the crankshaft, and the slot of the rocker member is configured to vary a distance between the longitudinal axis of the crankpin and the distal end of the connecting rod. The engine may be configured such that as the crankshaft rotates, reversal of the direction of travel of the piston within the cylinder is delayed via relative motion between the slot of the rocker member and the crankpin after the piston reaches at least one of the stroke termination points.

According to yet another aspect, an internal combustion engine may include a cylinder block defining a cylinder and a crankshaft including a crankpin. The crankshaft is rotatably received by the cylinder block and rotates along a longitudinal axis, and the crankpin defines a longitudinal axis parallel to and offset by a distance with respect to the longitudinal axis along which the crankshaft rotates. The engine may further include a piston configured to reciprocate within the cylinder and a connecting rod including a distal end and a proximal end, wherein the distal end is operably coupled to the piston. The engine may also include a rocker member including a pivot portion, a coupling portion, and a slot, wherein the pivot portion is operably coupled to the cylinder block, the coupling portion is operably coupled to the proximal end of the connecting rod, and the slot is operably coupled to the crankpin. A line extending between the longitudinal axis along which the crankshaft rotates and the longitudinal axis of the crankpin defines a radial axis of the crankshaft. The slot of the rocker member is configured to vary a distance between the longitudinal axis of the crankpin and the distal end of the connecting rod. The engine may be configured to selectively operate in two modes, including a first mode, wherein the distance between the longitudinal axis of the crankpin and the distal end of the connecting rod is substantially fixed regardless of a radial position of the radial axis of the crankshaft, and a second mode, wherein the distance between the longitudinal axis of the crankpin and the distal end of the connecting rod varies based on the radial position of the radial axis of the crankshaft.

According to yet further aspect, a power train may include an internal combustion engine, a transmission operably coupled to the engine, and a drive member configured to perform work. The drive member may be operably coupled to the transmission.

According to still a further aspect, a vehicle may include an internal combustion engine, a transmission operably coupled to the engine, and a drive member configured to perform work. The drive member may be operably coupled to the transmission.

Additional objects and advantages of the disclosure will be set forth in part in the description which follows, or may be learned by practice of the disclosed embodiment.

Aside from the structural and procedural arrangements set forth above, the embodiment could include a number of other arrangements, such as those explained hereinafter. It is to be understood that both the foregoing description and the following description are exemplary only.

### BRIEF DESCRIPTION OF THE DRAWINGS

The accompanying drawings, which are incorporated in and constitute a part of this description, illustrate an exemplary embodiment and together with the description, serve to explain the principles of the embodiment. In the drawings,

FIG. 1 is a schematic partial perspective view of an exemplary embodiment of an internal combustion engine;

FIG. 2 is a schematic partial perspective view of a portion of the exemplary embodiment shown in FIG. 1;

FIG. 3 is a schematic view of an exemplary embodiment of a crankshaft for the exemplary embodiment shown in FIG. 1;

FIG. 4 is a schematic partial perspective section view of an exemplary portion of the exemplary embodiment shown in FIG. 1;

FIG. 5 is a schematic partial end section view of the exemplary embodiment shown in FIG. 1 with the radial axis angle of the crankshaft shown at 0 degrees;

FIG. 6 is a schematic partial end section view of the exemplary embodiment shown in FIG. 1 with the radial axis angle of the crankshaft shown at 40 degrees;

FIG. 7 is a schematic partial end section view of the exemplary embodiment shown in FIG. 1 with the radial axis angle of the crankshaft shown at 60 degrees;

FIG. 8 is a schematic partial end section view of the exemplary embodiment shown in FIG. 1 with the radial axis angle of the crankshaft shown at 120 degrees;

FIG. 9 is a schematic partial end section view of the exemplary embodiment shown in FIG. 1 with the radial axis angle of the crankshaft shown at 180 degrees;

FIG. 10 is a schematic partial end section view of the exemplary embodiment shown in FIG. 1 with the radial axis angle of the crankshaft shown at 300 degrees;

FIG. 11 is a schematic partial end section view of the exemplary embodiment shown in FIG. 1 with the radial axis angle of the crankshaft shown at 320 degrees; and

FIG. 12 is a schematic partial end section view of the exemplary embodiment shown in FIG. 1 with the radial axis angle of the crankshaft shown at 0/360 degrees.

### DESCRIPTION OF EXEMPLARY EMBODIMENT

Reference will now be made in detail to an exemplary embodiment. Wherever possible, the same reference numbers are used in the drawings and the description to refer to the same or like parts.

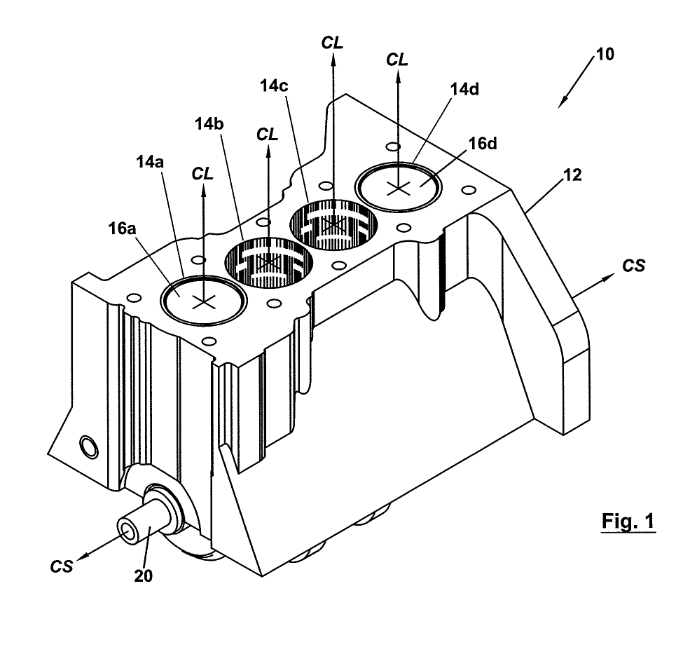

Exemplary engine 10 shown in FIGS. 1-12 is a reciprocating-piston internal combustion engine. As shown in FIG. 1, engine 10 includes a cylinder block 12. Cylinder block 12 defines a number of cylinders 14, each defining a longitudinal axis CL. In the exemplary embodiment shown, engine 10 has an in-line configuration and four cylinders 14a, 14b, 14c, and 14d. Although exemplary engine 10 has a configuration commonly referred to as an “in-line four” configuration, engine 10 may have other configurations known to those skilled in the art, such as, for example, configurations commonly referred to as “V,” “W,” “H,” “flat,” “horizontally-opposed,” and “radial.” Further, although exemplary engine 10 has four cylinders, engine 10 may have other numbers of cylinders known to those skilled in the art, such as, for example, one, two, three, five, six, eight, twelve, sixteen, twenty, and twenty-four. Thus, engine 10 may have, for example, any one of configurations commonly referred to as “flat-four,” “flat-six,” “in-line six,” “V-6,” “straight-eight,” “V-8,” “V-10,” “V-12,” “W-12,” and “H-16.” Further, although exemplary engine 10 is described herein in relation to four-stroke operation, other operations known to those skilled in the art are contemplated, such as, for example, two-stroke, three-stroke, five-stroke, and six-stroke operation. Exemplary engine 10 may be a spark-ignition engine, compression-ignition engine, or combinations and/or modifications thereof known to those skilled in the art.

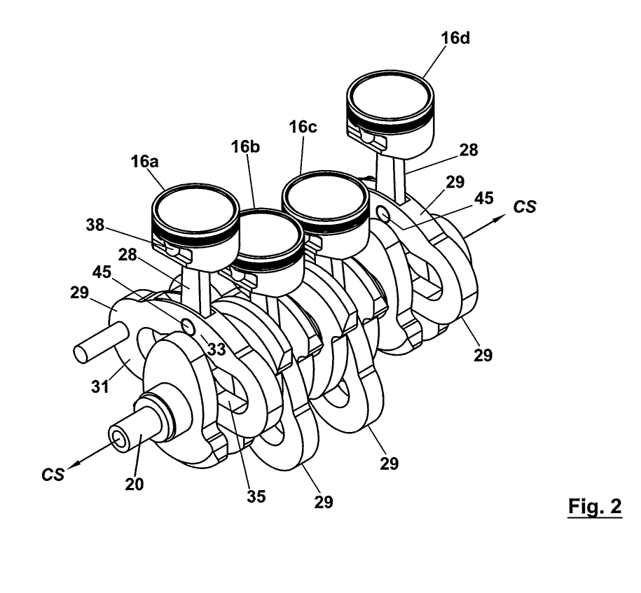

As shown in FIGS. 1 and 2, exemplary engine 10 includes pistons 16 corresponding to cylinders 14, for example, four pistons 16a, 16b, 16c, and 16d. As shown in FIG. 1, pistons 16a and 16d are positioned in the upper end (i.e., “upper” being relative to the orientation of engine 10 shown in FIG. 1) of cylinders 14a and 14d, respectively, while pistons 16b and 16c are not visible in FIG. 1 due to being positioned lower in the cylinders 14b and 14c, respectively. To the extent that the relative positions of the pistons 16 in the cylinders 14 tend to indicate a relative firing order of engine 10 (i.e., the sequential order of combustion events as identified by cylinders), exemplary engine 10 may be configured to have a different firing order, as is known to those skilled in the art.

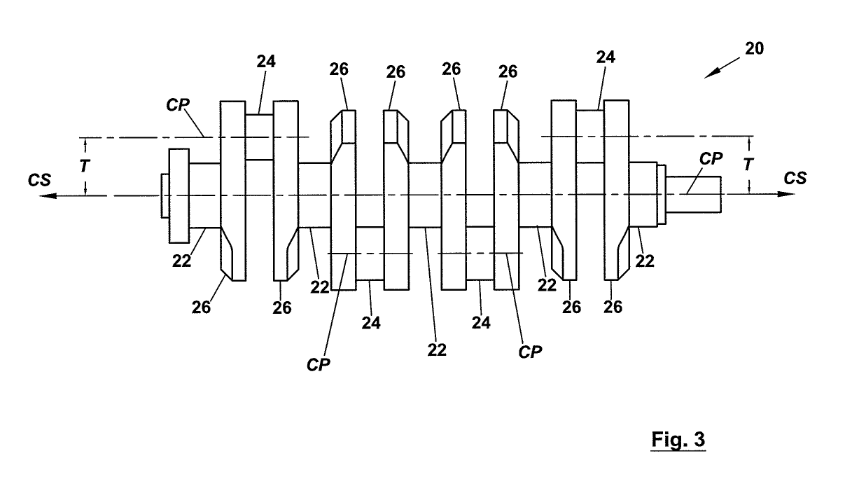

Cylinder block 12 of exemplary engine 10 defines a number of bearings (not shown) for receiving a crankshaft 20, such that crankshaft 20 may rotate relative to cylinder block 12 along a longitudinal axis CS defined by crankshaft 20. For example, as shown in FIG. 3, crankshaft 20 defines a number of journals 22 corresponding to the number of bearings defined by cylinder block 12, and journals 22 are received by bearings, such that crankshaft 20 may rotate along longitudinal axis CS.

Exemplary crankshaft 20 also defines a number of crankpins 24 corresponding to the number of pistons 16. Crankpins 24 are circular in cross section, and the respective circular cross-sections may define a center C, which, in turn, defines a longitudinal crankpin axis CP extending in a perpendicular manner through center C of the cross-section of the respective crankpin 24, such that crankpin axis CP is parallel and offset with respect to crankshaft axis CS. For example, crankpin axis CP is spaced a distance T from the longitudinal axis CS of crankshaft 20. Crankshaft 20 may also include a number of counterbalance weights 26 for providing (or improving) rotational balance of crankshaft 20 when assembled with pistons 16 and connecting rods.

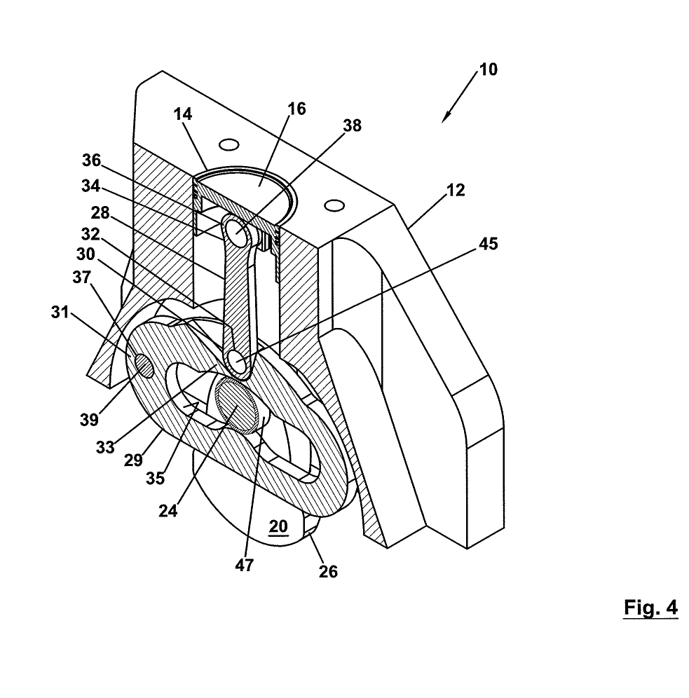

Referring to FIG. 2, for example, pistons 16 are operably coupled to crankpins 24 via a number of connecting rods 28 and rocker members 29 corresponding to the number of pistons 16. For example, exemplary connecting rods 28 (see, e.g., FIG. 4) include a proximal end 30 having a first aperture 32 and a distal end 34 having a second aperture 36. Exemplary rocker members 29 include pivot portions 31 operably coupled to cylinder block 12, coupling portions 33 operably coupled to respective proximal ends 30 of connecting rods 28, and slots 35 operably coupled to respective crankpins 24. Distal ends 34 of connecting rods 28 may be operably coupled to respective pistons 16 via, for example, respective pins 38.

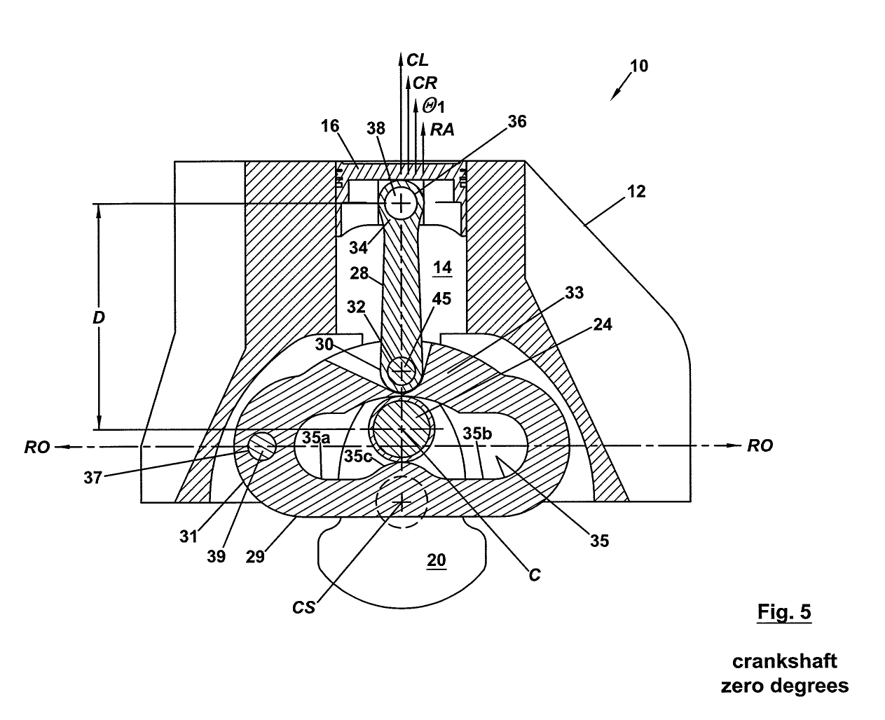

According to the exemplary engine 10 shown in FIGS. 1-12, exemplary rocker member 29 is configured to vary the distance D from the center C of crankpin 24 and distal end 34 of connecting rod 28 (e.g., the center of aperture 36) (see, e.g., FIG. 5). For example, as crankshaft 20 rotates, rocker member 29 pivots about pivot portion 31, and crankpin 24 travels in slot 35. As a result, the distance D from the center C of crankpin 24 and distal end 34 of connecting rod 28 varies such that, for example, the distance between the center C of crankpin 24 and an upper surface of piston 16 varies. In the exemplary embodiment shown, the distance D may be selectively altered via mechanical operation.

Referring to FIG. 5, pivot portion 31 of exemplary rocker member 29 includes a pivot aperture 37 configured to receive a pin 39 that is operably coupled to cylinder block 12. Rocker member 29 pivots about pivot aperture 37 as crankpin 24 of crankshaft 20 rotates. Pin 39 may be configured to be adjustable such that pivot portion of 31 of rocker member 29 moves relative to longitudinal axis CS of crankshaft 20. For example, pin 39 may be one or more elongated rods extending substantially parallel to longitudinal axis CS of crankshaft 20, and the one or more of the elongated rods may be operably coupled to cylinder block 12 in a manner that permits selective movement of the one or more rods relative to crankshaft 20 to vary the effect of an associated rocker member 29 on the distance D between the center C of crankpin 24 and the distal end 34 of connecting rod 28. As explained in more detail herein, this exemplary configuration may permit tailoring of the operation characteristics (e.g., power output, torque, efficiency, and/or responsiveness) of exemplary engine 10. Although the exemplary rocker member 29 shown in FIGS. 1-12 is operably coupled to cylinder block 12 in an indirect manner via pin 39, rocker member 29 may be coupled directly to cylinder block 12 via, for example, bosses integrally-formed with cylinder block 12. Further, other arrangements for coupling rocker member 29 to engine 10 are contemplated.

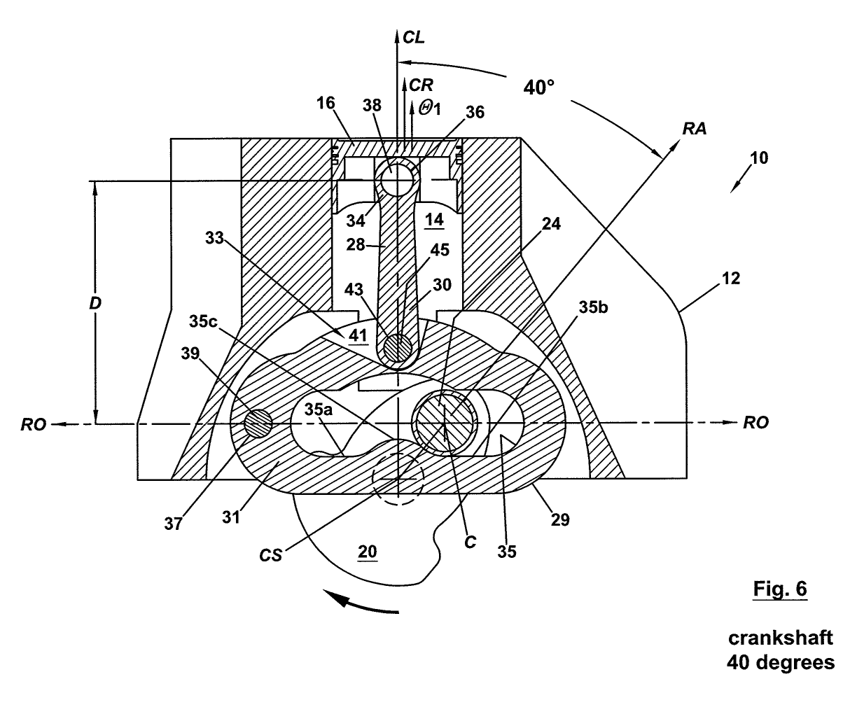

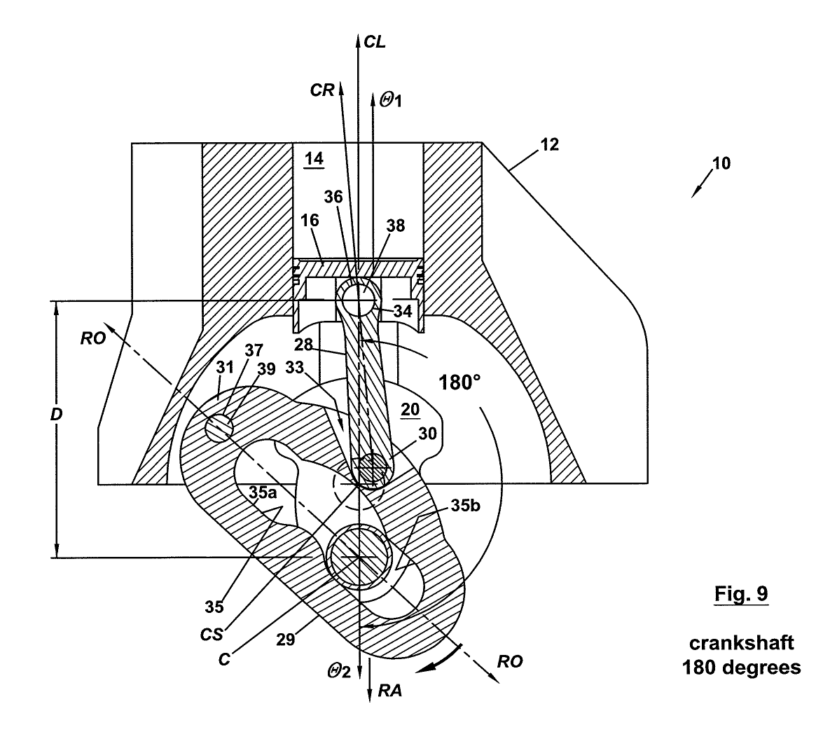

As shown in FIG. 6, exemplary rocker member 29 includes an exemplary coupling portion 33 having a recess 41 for receiving proximal end 30 of connecting rod 28. Recess 41 may have a generally v-shaped clearance in cross-section and may include one or more apertures 43 for receiving an ankle pin 45, which operably couples connecting rod 28 to rocker member 29. As shown in FIG. 6, the cross-section of the exemplary v-shaped clearance is asymmetric with respect to aperture(s) 43, which provides more clearance for pivoting action between connecting rod 28 and rocker member 29 (see, e.g., FIG. 9). Other arrangements for operably coupling connecting rod 28 to rocker member 29 are contemplated.

Slot 35 of exemplary rocker member 29 may be configured to tailor the manner in which the distance D between the center C of crankpin 24 and distal end 34 varies as crankshaft 20 rotates. As shown in FIG. 5, exemplary rocker member 29 defines a rocker axis RO extending from, for example, the center of pivot aperture 37 and along slot 35. Exemplary slot 35 includes two straight portions (e.g., a first straight portion 35a and a second straight portion 35b) extending substantially parallel to rocker axis RO (e.g., with rocker axis RO substantially bisecting the straight portions 35a and 35b of slot 35). First and second straight portions 35a and 35b are separated by a curved portion 35c. For example, exemplary curved portion 35c of slot 35 may have a width and/or radius, such that as crankpin 24 revolves around longitudinal axis CS of crankshaft 20, proximal end 30 of connecting rod 28 does not move as crankpin 24 moves, at least for a range of radial movement of crankshaft 20. As explained in more detail herein, this exemplary configuration may permit tailoring of the operation characteristics (e.g., power output, torque, efficiency, and/or responsiveness) of exemplary engine 10.

As shown in FIG. 4, a bushing 47 may be provided on crankpin 24, for example, in order to reduce friction and/or wear associated with relative movement between rocker member 29 and crankpin 24 as crankpin 24 moves within slot 35. Other arrangements for reducing friction and/or wear are contemplated.

According to the exemplary embodiment shown in FIGS. 1-12, interaction between crankpin 24 and rocker member 29 may be configured and/or controlled such that substantial movement of piston 16 toward crankshaft 20 during the power stroke is delayed until crankshaft 20 has rotated to point at which there is a more effective moment arm between the transmission of the combustion force on piston 16 and a radial axis RA extending between crankshaft axis CS and a respective crankpin axis CP. For example, slot 35 of rocker member 29 may be shaped such that crankpin 24 moves within slot 35 as crankshaft 20 rotates without any, or any significant amount of, movement of distal end 34 of connecting rod 28, thereby effectively increasing the distance D between the center C of crankpin 24 and distal end 34 of connecting rod 28. As a result, a greater amount of the energy of the combustion event may be captured because the maximum force acting on piston 16 coincides with a greater moment arm, thereby resulting in more torque at crankshaft 20 during the power stroke. Timing of initiation of combustion may be tailored to take advantage of the delayed stroke.

During operation of exemplary engine 10, as crankshaft 20 rotates, crankpins 24 revolve around crankshaft longitudinal axis CS, such that crankpin centers C define a circular path having a radius defined by the distance T defined along a radial axis RA (see FIGS. 5-12) extending between the longitudinal axis CS of crankshaft 20 and the longitudinal axis CP of the respective crankpins 24. Thus, first apertures 32 of proximal ends 30 of connecting rods 28, which are coupled to crankpins 24 via rocker members 29, move based on pivoting motion of rocker members 29 and/or movement within slots 35 of rocker members 29, as explained in more detail below with respect to FIGS. 5-12. Distal ends 34 of connecting rods 28 are constrained to move in a reciprocating and linear manner due to being operably coupled to pistons 16, which are likewise constrained to move in a reciprocating and linear manner within respective cylinders 14 defined by cylinder block 12. As a result, as crankshaft 20 rotates, pistons 16 reciprocate within respective cylinders 14, defining a piston stroke generally corresponding to twice the distance T between the crankpin axis CP and the crankshaft axis CS (as affected according to the exemplary operation described herein).

During operation of a conventional engine, a piston reciprocates within the cylinder, such that during a power stroke of the internal combustion engine, combustion of an air/fuel mixture within a combustion chamber defined by the piston, cylinder, and a cylinder-head forces the piston toward the crankshaft. As the piston travels toward the crankshaft, the crankshaft is rotated via the connecting rod and crankpin, thereby converting the potential energy associated with the compressed air/fuel mixture into mechanical work.

Due to the architecture of a conventional internal combustion engine, however, when the piston is at a position within the cylinder that coincides with the maximum compression (i.e., the combustion chamber is at its lowest volume, this condition generally coinciding with maximum compression, when the piston is farthest from the crankshaft), the radial axis extending between the center of the crankshaft and the center of the crankpin tends to be nearly co-linear, if not co-linear, with the axis of the connecting rod. At these relative positions, as the piston first begins its movement toward the crankshaft during the power stroke, there is only a very short moment arm (if any) extending between the axis of the connecting rod and the radial axis. As a result, the force initially created by the air/fuel mixture at the moment of combustion does not transfer as much torque to the crankshaft as it would if the length of the moment arm were greater. This situation may be particularly undesirable because, during combustion and very shortly thereafter, the force on the piston due to the combustion event may approach its maximum magnitude. Further, as the piston travels down the cylinder toward the crankshaft and the length of the moment arm increases, the magnitude of the force from the combustion event acting on the piston may dissipate rapidly. Thus, because there is a very short moment arm created between the axis of the connecting rod and the radial axis during the time of maximum force on the piston, efficiency of the work generated from the combustion process in a conventional internal combustion engine may be less than desired.

Exemplary engine 10 is configured to selectively employ a strategy that delays substantial movement of piston 16 toward crankshaft 20 during the power stroke, until crankshaft 20 has rotated to a point at which there is a more effective moment arm between the combustion force on piston 16 and radial axis RA extending between crankshaft axis CS and a respective crankpin axis CP. As a result, a greater amount of the energy of the combustion event may be captured because the maximum force acting on piston 16 coincides with a greater moment arm, thereby resulting in more torque at crankshaft 20 during the power stroke. Timing of the initiation of combustion may be tailored to take advantage of the delayed stroke.

For example, if piston 16 would have normally reversed its direction of travel where radial axis RA of crankshaft 20 is at 0 degrees, piston 16 may (1) reach its stroke termination point with radial axis RA at zero degrees and then delay its reversal of direction until a larger moment arm exists between connecting rod 28 and crankshaft axis CS, or (2) continue to move in cylinder 14 in a direction away from crankshaft 20, even after radial axis RA has reached 0 degrees and delay its reversal of direction until a larger moment arm exists between connecting rod 28 and crankshaft axis CS. As a result, a greater amount of the energy of the combustion event may be captured because the maximum force acting on piston 16 coincides with a greater moment arm, thereby resulting in more torque at crankshaft 20 during the power stroke.

FIGS. 5-12 schematically illustrate exemplary operation of engine 10 having exemplary rocker member 29, which may serve to delay piston 16's travel at the beginning of the power stroke of engine 10. For example, slot 35 of rocker member 29 may be shaped such that crankpin 24 moves within slot 35 as crankshaft 20 rotates without moving distal end 34 of connecting rod 28, thereby effectively increasing the distance D between the center C of crankpin 24 and distal end 34 of connecting rod 28. Such an exemplary embodiment renders it possible to effectively hold piston 16 in cylinder 14 at a substantially fixed position for a short period of time, even as crankpin 24 continues to revolve around crankshaft 20's axis CS as crankshaft 20 rotates. As a result, it is possible to hold piston 16 at the point of highest compression in the combustion chamber while crankpin 24 revolves to a position, which results in an increased moment arm defined by the transmission of the force acting on piston 16 and the radial axis RA extending between the center of crankshaft 20 and the center C of crankpin 24. This results in relatively more torque being applied to crankshaft 20 as combustion begins, with piston 16 still remaining at a point farthest from the center of crankshaft 20 (i.e., at the end of its upward stroke as shown). In this exemplary manner, the delaying strategy outlined below may be implemented.

For example, as shown in FIG. 5, crankshaft 20 is oriented such that radial axis RA defined by the center of crankshaft 20 and the center C of crankpin 24 is oriented at zero degrees, which corresponds generally to a first stroke termination angle θ₁ that generally coincides with the end of the compression stroke (and exhaust stroke in a four-stroke engine) of exemplary engine 10. Thus, with radial axis RA in this orientation, piston 16 is at its upper position within cylinder 14.

As shown in FIG. 5, during operation of engine 10, crankshaft 20 rotates in the clockwise direction. Crankpin 24 is positioned in exemplary curved portion 35c of rocker member 29's slot 35, such that piston 16 is at the top of its stroke while the radial axis RA of crankshaft 20 is substantially aligned with the longitudinal axis CR of connecting rod 28. This position and exemplary configuration results in the distance D between the center C of crankpin 24 and distal end 34 (e.g., the center of second aperture 36) of connecting rod 28 being reduced relative to the distance D shown in FIGS. 6-9. As shown in the exemplary arrangement of FIG. 5, the rocker axis RO is substantially horizontal.

FIG. 6 shows crankshaft 20 in an orientation where radial axis RA has rotated 40 degrees past first stroke termination angle θ₁. In a conventional engine, piston 16 would have traveled a significant distance toward crankshaft axis CS as radial axis RA rotated through 40 degrees. In contrast, according to exemplary engine 10, piston 16 has not yet started its downward travel toward crankshaft axis CS. Instead, crankpin 24 has moved within curved portion 35c of slot 35 in a manner resulting in no movement of proximal end 30 or distal end 34 of connecting rod 28. As a result, the distance D between the center C of crankpin 24 and distal end 34 of connecting rod 28 has increased relative the distance D shown in FIG. 5. As a result of this increase in the distance D, piston 16 has not started to travel down cylinder 14, even though crankpin 24 has rotated clockwise relative to the center C of crankshaft 20, such that the center C of crankpin 24 is farther from the top of cylinder 14. (See the Table below showing an exemplary relationship for exemplary engine 10 between radial axis RA's angle and piston 16's displacement relative to the first stroke termination angle θ₁.) As a result, the distance D increases, such that rather than beginning downward travel in cylinder 14, piston 16 remains substantially in its position of maximum stroke. Rocker axis RO has remained in a substantially horizontal orientation due to the exemplary configuration of slot 35.

TABLE
RADIAL AXIS RA ANGLE VS. PISTON DISPLACEMENT
RELATIVE TO ZERO DEGREES FOR FIGS. 1-12

| Crank | Piston |
|---|---|
| Angle | Depth |
| 0 | 0.000 |
| 4 | 0.000 |
| 8 | 0.000 |
| 12 | 0.000 |
| 16 | 0.000 |
| 20 | 0.000 |
| 24 | 0.000 |
| 28 | 0.000 |
| 32 | 0.000 |
| 36 | 0.000 |
| 40 | 0.000 |
| 44 | 0.068 |
| 48 | 0.139 |
| 52 | 0.213 |
| 56 | 0.289 |
| 60 | 0.369 |
| 64 | 0.451 |
| 68 | 0.536 |
| 72 | 0.622 |
| 76 | 0.711 |
| 80 | 0.801 |
| 84 | 0.893 |
| 88 | 0.986 |
| 92 | 1.080 |
| 96 | 1.176 |
| 100 | 1.272 |
| 104 | 1.368 |
| 108 | 1.465 |
| 112 | 1.562 |
| 116 | 1.660 |
| 120 | 1.757 |
| 124 | 1.853 |
| 128 | 1.950 |
| 132 | 2.045 |
| 136 | 2.140 |
| 140 | 2.234 |
| 144 | 2.327 |
| 148 | 2.418 |
| 152 | 2.508 |
| 156 | 2.596 |
| 160 | 2.682 |
| 164 | 2.766 |
| 168 | 2.849 |
| 172 | 2.928 |
| 176 | 3.006 |
| 180 | 3.080 |

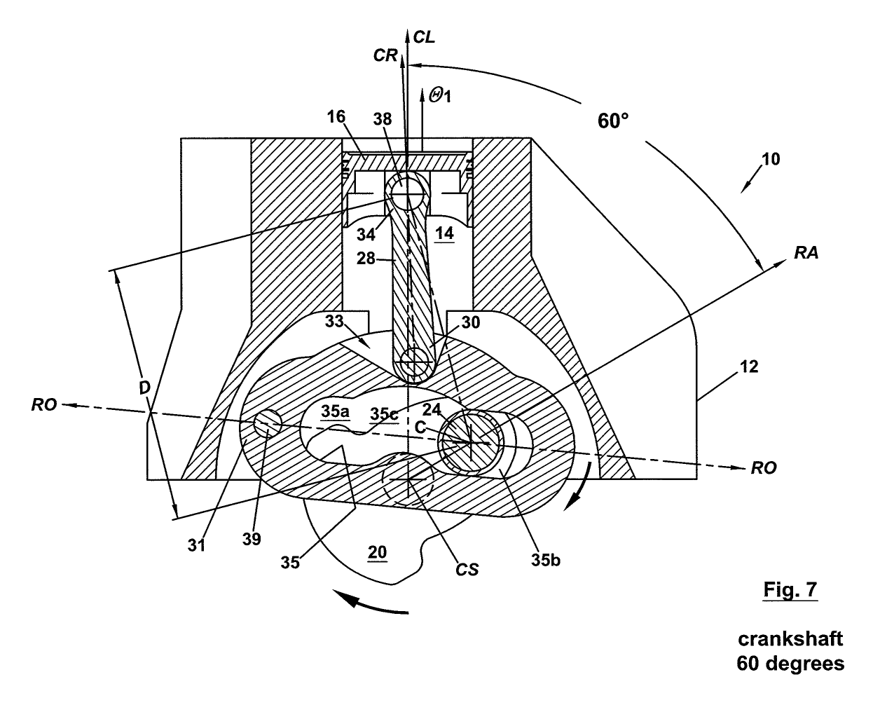

Referring to FIG. 7, when the radial axis RA has rotated to 60 degrees past the first stroke termination angle θ₁, combustion has commenced, thereby driving piston 16 partially down cylinder 14. Crankpin 24 has reached second straight portion 35b of slot 35, such that continued movement of crankpin 24 causes rocker member 29 to pivot about pivot portion 31, as shown by virtue of rocker axis RO revolving away from its horizontal orientation. At this position of radial axis RA, radial axis RA is no longer aligned with the longitudinal axis CR of connecting rod 28. As combustion force on piston 16 pushes down on rocker member 29 at coupling portion 33, pivot portion 31 causes force on piston 16 to be directed to crankpin 24 at the position where crankpin 24 contacts the inside of slot 35. This exemplary arrangement results in an increased moment arm for driving crankshaft 20 in the clockwise direction (as shown). As compared to an engine having a conventional architecture, this results in relatively more torque being applied to crankshaft 20 as combustion begins between 40 and 60 degrees past first stroke termination angle θ₁. As a result of rocker axis RO revolving away from its horizontal orientation, the distance D between the center C of crankpin 24 and distal end 34 of connecting rod 28 has increased relative to the distance D shown in FIGS. 5 and 6.

Although the exemplary embodiment shown in FIGS. 5-12 shows the point at which piston 16 begins to move from its point of maximum stroke to be where radial axis RA has rotated 40 degrees past first stroke termination angle θ₁, this point may be between 40 and 60 degrees past first stroke termination angle θ₁ (e.g., 59 degrees, 55 degrees, 50 degrees, 45 degrees, or 41 degrees). According to some embodiments, the radial position of crankshaft 20 at which the piston 16 begins to move from its point of maximum stroke may be adjusted during operation according to predetermined criteria in order to tailor operation of engine 10, as explained in more detail herein.

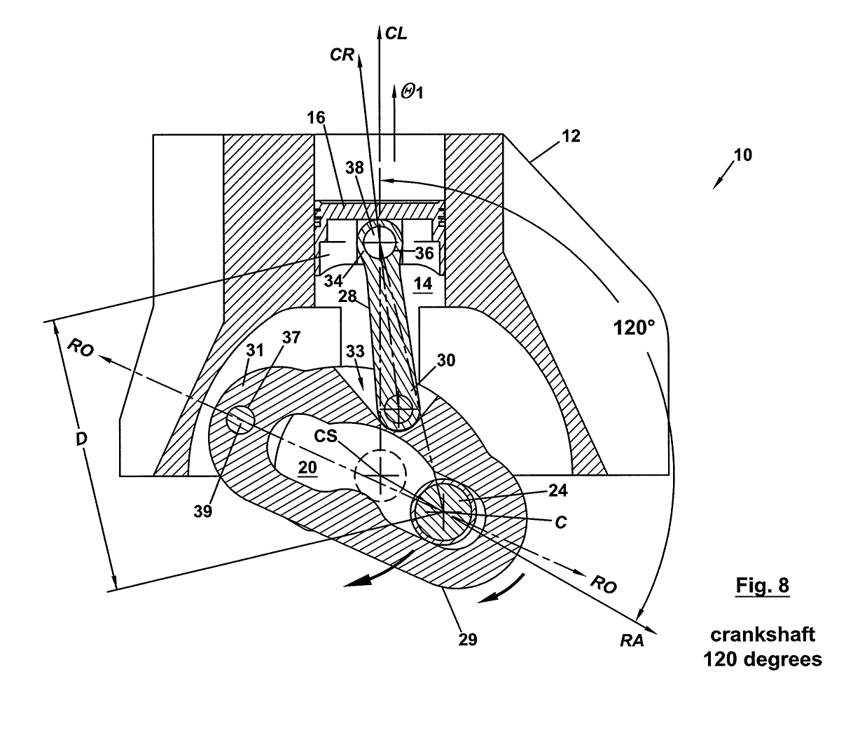

Referring to FIG. 8, radial axis RA has rotated 120 degrees past first stroke termination angle θ₁. As shown, rocker axis RO has pivoted farther from horizontal relative to FIG. 7 as piston 16 travels farther down cylinder 14, and connecting rod 28 drives rocker member 29 to pivot about pivot portion 31. Crankpin 24 continues to travel farther into second straight portion 35b of slot 35. As rocker axis RO continues to revolve farther away from its horizontal orientation, the distance D between the center C of crankpin 24 and distal end 34 of connecting rod 28 continues to increase relative to the distance D shown in FIG. 7.

As shown in FIG. 9, radial axis RA has rotated to 180 degrees past the first stroke termination angle θ₁ (i.e., at a second stroke termination angle θ₂, which corresponds generally to the end of the power stroke). Rocker axis RO has pivoted farther from horizontal relative to FIG. 8 as piston 16 has traveled farther down cylinder 14 to its second stroke termination point, which corresponds to the end of the power stroke and the beginning of the exhaust stroke (for a four-stroke engine). Connecting rod 28 has driven rocker member 29 to pivot farther about pivot portion 31. Crankpin 24 has reversed directions within slot 35, and travels back toward curved portion 35c of slot 35. The distance D has now shortened relative to FIG. 9 as crankpin 24 slides back toward curved portion 35c of slot 35.

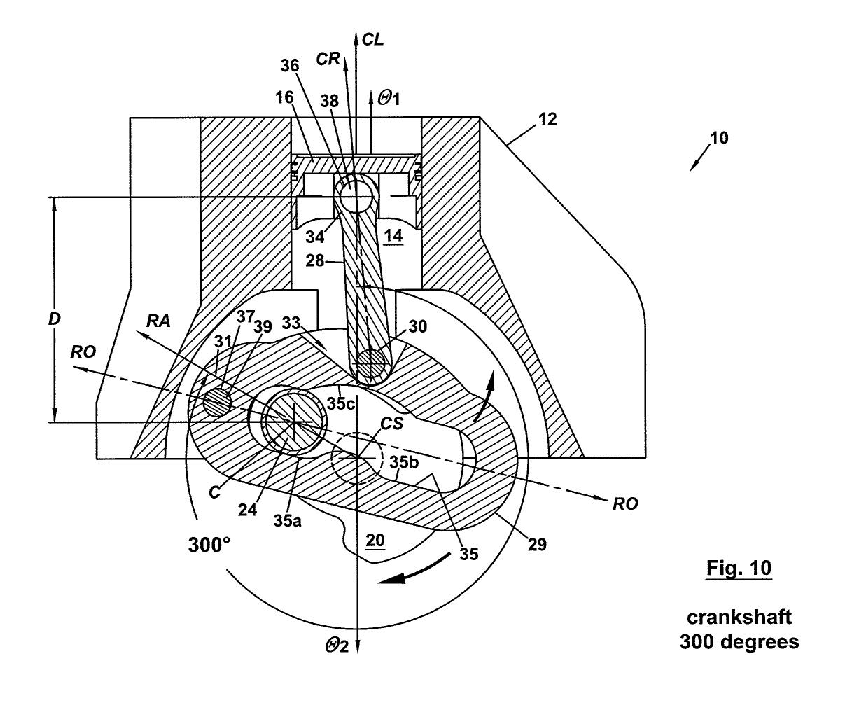

Referring to FIG. 10, radial axis RA has rotated to 300 degrees past the first stroke termination angle θ₁ (i.e., 120 degrees past second stroke termination angle θ₂). Rocker axis RO has reversed its pivoting direction and has returned to an orientation closer to horizontal relative to FIG. 9. Piston 16 has reversed direction and has traveled partially up cylinder 14. Combustion and power stroke having been completed, crankpin 24 has traveled through curved portion 35c of slot 35 and drives rocker member 29 via first straight portion 35a to pivot counterclockwise about pivot portion 31. Relative to FIG. 9, the distance D between the center C of crankpin 24 and distal end 34 of connecting rod 28 continues to shorten as crankpin 24 slides through curved portion 35c of slot 35 and into first straight portion 35a.

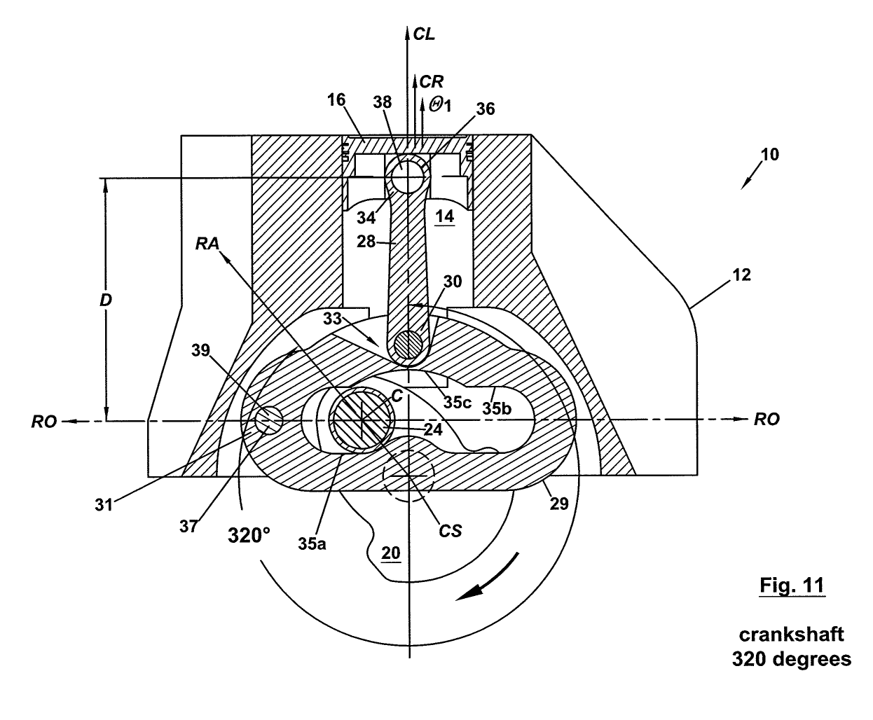

Referring to FIG. 11, radial axis RA has rotated to 320 degrees past the first stroke termination angle θ₁, which also corresponds to 40 degrees before the first stroke termination angle θ₁ with respect to the next revolution of crankshaft 20. As shown in FIG. 11, rocker axis RO has returned to its substantially horizontal orientation (see FIGS. 5 and 6), and piston 16 is substantially at the end of its upward stroke. Crankpin 24 is at a point of transition between first straight portion 35a and curved portion 35c of slot 35. Distance D between the center C of crankpin 24 and distal end 34 of connecting rod 28 has increased relative to FIG. 10 as crankpin 24 has traveled back toward curved portion 35c of slot 35.

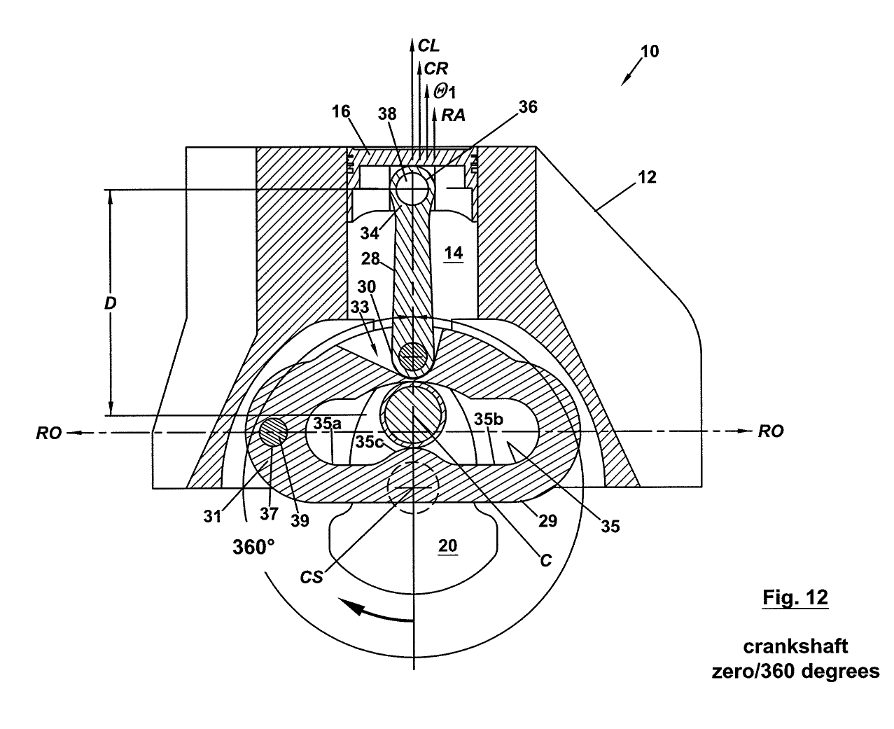

Referring to FIG. 12, radial axis RA has rotated to 360 degrees past the first stroke termination angle θ₁, and thus, has returned to the first stroke termination angle θ₁ shown in FIG. 5. As shown in FIG. 12, rocker axis RO has remained in its substantially horizontal orientation, and piston 16 has remained substantially at the end of its upward stroke. Thus, even though crankpin 24 has moved significantly as crankshaft 20 has rotated through 40 degrees (from radial axis RA being at 320 degrees to 360 degrees), crankpin 24 has followed curved portion 35c of slot 35 of rocker member 29, such that rocker member 29, connecting rod 28, and piston 16 have remained stationary and in the same relative orientation shown in FIG. 11. Relative to FIG. 11, distance D between the center C of crankpin 24 and distal end 34 of connecting rod 28 has decreased and has offset the movement of crankpin 24 toward piston 16.

In the exemplary manner described above, the distance D between the center C of crankpin 24 and distal end 34 of connecting rod 28 is variable, such that the distance between the center of pin 38, which operably couples connecting rod 28 to piston 16, and the center C of crankpin 24 is variable. More specifically, the distance D is variable (see, e.g., FIGS. 5-12), the variability of the distance D being facilitated in the exemplary embodiment by virtue of rocker member 29. As radial axis RA rotates between first stroke termination angle θ₁ and 180 degrees past first stroke termination angle θ₁ (i.e., to second stroke termination angle θ₂), the distance D initially increases, thereby delaying initiation of the power stroke until radial axis RA reaches a point, for example, at least 40 degrees past first stroke termination angle θ₁ in the exemplary embodiment shown. Timing of the initiation of combustion may be tailored to take advantage of this delay. The distance D continues to increase as radial axis RA continues to rotate toward an orientation 180 degrees past first stroke termination angle θ₁. As the radial axis RA rotates between 180 and 360 degrees past first stroke termination angle θ₁, the distance D is decreases.

According to some embodiments, the exemplary configuration and/or interaction can be tailored to achieve desired performance characteristics of exemplary engine 10, such as, for example, improved efficiency, improved torque, improved power output, and/or improved responsiveness. For example, the configuration of the rocker member, including the slot shape, the position of the pivot portion, and/or the position of the coupling portion, may be selected to improve efficiency and/or power of exemplary engine 10, for example, by changing at least one of the timing and magnitude of the delay of initiation of the power stroke.

According to some embodiments, initiation of the power stroke of exemplary engine 10 may be delayed until radial axis RA has rotated at least about 15 degrees beyond the first stroke termination angle θ₁. In other embodiments, initiation of the power stroke may be delayed until radial axis RA has rotated at least about 30 degrees beyond the first stroke termination angle θ₁ (e.g., at least about 40 or 45 degrees beyond the first stroke termination angle θ₁). In other embodiments, rotation may be set to about 25 or 35 degrees beyond the first stroke termination angle θ₁, for example, to achieve a desired performance characteristic of engine 10.

According to some embodiments, engine 10 may be configured to selectively operate in at least two modes, for example, a fixed mode and/or a variable mode. For example, in a first mode of operation (i.e., a fixed-distance mode), wherein the distance D between the between the center C of crankpin 24 (e.g., the longitudinal axis CP of crankpin 24) and distal end 34 of connecting rod 28 is substantially fixed, regardless of the radial position of the radial axis RA. For example, pivot portion 31 of rocker member 29 may be operably coupled to cylinder block 12 in an adjustable manner that permits pivot portion to move relative to the longitudinal axis CR of crankshaft 20. Such a mode of operation may permit operation of engine 10 such that a minimum distance D is fixed so that there is substantially no delay in the downward travel of piston 16 as radial axis RA travels from first stroke termination angle θ₁ to 90 degrees, resulting in operation similar to a conventional engine of corresponding configuration. Effectively fixing the distance D may permit engine 10 to operate at relatively higher engine speeds when compared to operation in a mode in which the distance D is varied as described above with reference to FIGS. 5-12. Thus, operating according to the fixed-distance mode may be desirable when, for example, it is anticipated that the rotational speed of crankshaft 20 will be relatively high and/or it is desirable to operate engine 10 at a higher power output and/or with more responsiveness to throttle input than would be achievable in variable-distance mode.

According to a second mode of operation, a variable-distance mode of operation, the distance D between the between the center C of crankpin 24 (e.g., the longitudinal axis CP of crankpin 24) and distal end 34 of connecting rod 28 may be varied, for example, as explained with respect to FIGS. 5-12 above. It may be desirable to operate engine 10 according to the variable-length mode of operation to achieve greater efficiency relative to the fixed-distance mode of operation. According to some embodiments, engine 10 may operate according to a combination of the first and second modes.

Exemplary engine 10, may be incorporated into a power train, for example, including a transmission operably coupled to engine 10 and a drive member configured to perform work, the drive member being operably coupled to the transmission. For example, the drive member may include a propulsion device, such as, for example, a wheel or a propeller. According to some embodiments, such a power train may include a generator configured to convert rotational power into electrical power, the generator being operably coupled to exemplary engine 10. Such a power train may include a power storage device (e.g., one or more batteries) operably coupled to the generator and configured to store electrical power. According to some embodiments, the transmission may include one or more electric motors.

Moreover, exemplary engine 10 may be incorporated into a vehicle including a transmission operably coupled to engine 10 and a drive member configured to perform work and being operably coupled to the transmission. For example, the drive member may include a propulsion device, such as, for example, a wheel or a propeller. For example, the vehicle may be a car, van, truck, boat, ship, train, or air vehicle. Such a vehicle may include exemplary engine 10 operably coupled to a generator configured to convert rotational power into electrical power, and a power storage device operably coupled to the generator and configured to store electrical power. The transmission may be, for example, an electric motor.

At least some portions of exemplary embodiments of the systems outlined above may used in association with portions of other exemplary embodiments. Moreover, at least some of the exemplary embodiments disclosed herein may be used independently from one another and/or in combination with one another and may have applications to internal combustion engines not disclosed herein.

It will be apparent to those skilled in the art that various modifications and variations can be made to the structures and methodologies described herein. Thus, it should be understood that the invention is not limited to the subject matter discussed in the description. Rather, the present invention is intended to cover modifications and variations.

What is claimed is:

1. An internal combustion engine comprising:
a cylinder block defining a cylinder;
a crankshaft comprising a crankpin, wherein the crankshaft is rotatably received by the cylinder block and rotates along a longitudinal axis, and the crankpin defines a longitudinal axis parallel to and spaced from the longitudinal axis along which the crankshaft rotates;
a piston configured to reciprocate within the cylinder;
a connecting rod comprising a distal end and a proximal end, wherein the distal end is operably coupled to the piston; and
a rocker member comprising a pivot portion, a coupling portion, and a slot, wherein the pivot portion is operably coupled to the cylinder block, the coupling portion is operably coupled to the proximal end of the connecting rod, and the slot is operably coupled to the crankpin, and
wherein the slot of the rocker member is configured to vary a distance between the longitudinal axis of the crankpin and the distal end of the connecting rod.

2. The internal combustion engine of claim 1, wherein the pivot portion is operably coupled to the cylinder block via a pin.

3. The internal combustion engine of claim 2, wherein the pin is operably coupled to the cylinder block in an adjustable manner such that the pivot portion of the rocker member is configured to move relative to the longitudinal axis of the crankshaft.

4. The internal combustion engine of claim 2, wherein the pivot portion comprises a pivot aperture, and the rocker member is operably coupled to the cylinder block via the pin and the pivot aperture.

5. The internal combustion engine of claim 1, wherein the slot of the rocker member comprises a curved portion.

6. The internal combustion engine of claim 1, wherein the slot of the rocker member comprises a straight portion and a curved portion.

7. The internal combustion engine of claim 1, wherein the slot of the rocker member comprises a first straight portion, a curved portion, and a second straight portion.

8. The internal combustion engine of claim 7, wherein the curved portion is between the first straight portion and the second straight portion.

9. The internal combustion engine of claim 1, wherein the coupling portion of the rocker member comprises a recess receiving the proximal end of the connecting rod.

10. The internal combustion engine of claim 9, wherein the recess of the coupling portion comprises an aperture receiving an ankle pin operably coupling the proximal portion of the connecting rod to the rocker member.

11. The internal combustion engine of claim 9, wherein the recess defines a v-shaped clearance.

12. The internal combustion engine of claim 11, wherein the recess of the coupling portion comprises an aperture receiving an ankle pin operably coupling the proximal portion of the connecting rod to the rocker member, and wherein the v-shaped clearance is asymmetrical with respect to the aperture receiving the ankle pin.

13. The internal combustion engine of claim 1, further comprising a bushing on the crankpin.

14. An internal combustion engine comprising:
a cylinder block defining a cylinder;
a crankshaft comprising a crankpin, wherein the crankshaft is rotatably received by the cylinder block and rotates along a longitudinal axis, and the crankpin defines a longitudinal axis parallel to and spaced from the longitudinal axis along which the crankshaft rotates;
a piston configured to reciprocate within the cylinder;
a connecting rod comprising a distal end and a proximal end, wherein the distal end is operably coupled to the piston; and
a rocker member comprising a pivot portion, a coupling portion, and a slot, wherein the pivot portion is operably coupled to the cylinder block, the coupling portion is operably coupled to the proximal end of the connecting rod, and the slot is operably coupled to the crankpin, and
wherein the rocker member is configured such that relative motion between the slot and the crankpin results in a distance between the longitudinal axis of the crankpin and an upper surface of the piston being variable.

15. The internal combustion engine of claim 14, wherein the pivot portion is operably coupled to the cylinder block via a pin.

16. The internal combustion engine of claim 15, wherein the pin is operably coupled to the cylinder block in an adjustable manner such that the pivot portion of the rocker member is configured to move relative to the longitudinal axis of the crankshaft.

17. The internal combustion engine of claim 15, wherein the pivot portion comprises a pivot aperture, and the rocker member is operably coupled to the cylinder block via the pin and the pivot aperture.

18. The internal combustion engine of claim 14, wherein the slot of the rocker member comprises a curved portion.

19. The internal combustion engine of claim 14, wherein the slot of the rocker member comprises a straight portion and a curved portion.

20. The internal combustion engine of claim 14, wherein the slot of the rocker member comprises a first straight portion, a curved portion, and a second straight portion.

21. The internal combustion engine of claim 20, wherein the curved portion is between the first straight portion and the second straight portion.

22. The internal combustion engine of claim 14, wherein the coupling portion of the rocker member comprises a recess receiving the proximal end of the connecting rod.

23. The internal combustion engine of claim 22, wherein the recess of the coupling portion comprises an aperture receiving an ankle pin operably coupling the proximal portion of the connecting rod to the rocker member.

24. The internal combustion engine of claim 22, wherein the recess defines a v-shaped clearance.

25. The internal combustion engine of claim 24, wherein the recess of the coupling portion comprises an aperture receiving an ankle pin operably coupling the proximal portion of the connecting rod to the rocker member, and wherein the v-shaped clearance is asymmetrical with respect to the aperture receiving the ankle pin.

26. The internal combustion engine of claim 14, further comprising a bushing on the crankpin.

27. An internal combustion engine comprising:
a cylinder block defining a cylinder;
a crankshaft comprising a crankpin, wherein the crankshaft is rotatably received by the cylinder block and rotates along a longitudinal axis, and the crankpin defines a longitudinal axis parallel to and offset by a distance with respect to the longitudinal axis along which the crankshaft rotates;
a piston configured to reciprocate within the cylinder between spaced stroke termination points defining a stroke of the piston;
a connecting rod comprising a distal end and a proximal end, wherein the distal end is operably coupled to the piston; and
a rocker member comprising a pivot portion, a coupling portion, and a slot, wherein the pivot portion is operably coupled to the cylinder block, the coupling portion is operably coupled to the proximal end of the connecting rod, and the slot is operably coupled to the crankpin,
wherein a line extending between the longitudinal axis along which the crankshaft rotates and the longitudinal axis of the crankpin defines a radial axis of the crankshaft,
wherein the slot of the rocker member is configured to vary a distance between the longitudinal axis of the crankpin and the distal end of the connecting rod, and
wherein the engine is configured such that as the crankshaft rotates, reversal of the direction of travel of the piston within the cylinder is delayed via relative motion between the slot of the rocker member and the crankpin after the piston reaches at least one of the stroke termination points.

28. The engine of claim 27, wherein the reversal of the direction of travel of the piston within the cylinder is delayed until the radial axis of the crankshaft has rotated at least about 10 degrees past a point corresponding to the at least one stroke termination point.

29. The engine of claim 27, wherein the reversal of the direction of travel of the piston within the cylinder is delayed until the radial axis of the crankshaft has rotated at least about 20 degrees past a point corresponding to the at least one stroke termination point.

30. The engine of claim 27, wherein the reversal of the direction of travel of the piston within the cylinder is delayed until the radial axis of the crankshaft has rotated at least about 30 degrees past a point corresponding to the at least one stroke termination point.

31. The engine of claim 27, wherein the reversal of the direction of travel of the piston within the cylinder is delayed until the radial axis of the crankshaft has rotated at least about 40 degrees past a point corresponding to the at least one stroke termination point.

32. The internal combustion engine of claim 27, wherein the pivot portion is operably coupled to the cylinder block via a pin.

33. The internal combustion engine of claim 32, wherein the pin is operably coupled to the cylinder block in an adjustable manner such that the pivot portion of the rocker member is configured to move relative to the longitudinal axis of the crankshaft.

34. The internal combustion engine of claim 33, wherein the pivot portion comprises a pivot aperture, and the rocker member is operably coupled to the cylinder block via the pin and the pivot aperture.

35. The internal combustion engine of claim 27, wherein the slot of the rocker member comprises a curved portion.

36. The internal combustion engine of claim 27, wherein the slot of the rocker member comprises a straight portion and a curved portion.

37. The internal combustion engine of claim 27, wherein the slot of the rocker member comprises a first straight portion, a curved portion, and a second straight portion.

38. The internal combustion engine of claim 37, wherein the curved portion is between the first straight portion and the second straight portion.

39. The internal combustion engine of claim 27, wherein the coupling portion of the rocker member comprises a recess receiving the proximal end of the connecting rod.

40. The internal combustion engine of claim 39, wherein the recess of the coupling portion comprises an aperture receiving an ankle pin operably coupling the proximal portion of the connecting rod to the rocker member.

41. The internal combustion engine of claim 39, wherein the recess defines a v-shaped clearance.

42. The internal combustion engine of claim 41, wherein the recess of the coupling portion comprises an aperture receiving an ankle pin operably coupling the proximal portion of the connecting rod to the rocker member, and wherein the v-shaped clearance is asymmetrical with respect to the aperture receiving the ankle pin.

43. The internal combustion engine of claim 27, further comprising a bushing on the crankpin.

44. An internal combustion engine comprising:
a cylinder block defining a cylinder;
a crankshaft comprising a crankpin, wherein the crankshaft is rotatably received by the cylinder block and rotates along a longitudinal axis, and the crankpin defines a longitudinal axis parallel to and offset by a distance with respect to the longitudinal axis along which the crankshaft rotates;
a piston configured to reciprocate within the cylinder; and
a connecting rod comprising a distal end and a proximal end, wherein the distal end is operably coupled to the piston; and
a rocker member comprising a pivot portion, a coupling portion, and a slot, wherein the pivot portion is operably coupled to the cylinder block, the coupling portion is operably coupled to the proximal end of the connecting rod, and the slot is operably coupled to the crankpin,
wherein a line extending between the longitudinal axis along which the crankshaft rotates and the longitudinal axis of the crankpin defines a radial axis of the crankshaft,
wherein the slot of the rocker member is configured to vary a distance between the longitudinal axis of the crankpin and the distal end of the connecting rod, and
wherein the engine is configured to selectively operate in two modes, comprising:
a first mode, wherein the distance between the longitudinal axis of the crankpin and the distal end of the connecting rod is substantially fixed regardless of a radial position of the radial axis of the crankshaft, and
a second mode, wherein the distance between the longitudinal axis of the crankpin and the distal end of the connecting rod varies based on the radial position of the radial axis of the crankshaft.

45. The internal combustion engine of claim 44, wherein the engine is configured to switch between the first mode of operation and the second mode of operation via movement of the pivot portion of the rocker member.

46. The internal combustion engine of claim 45, wherein the pivot portion is operably coupled to the cylinder block in an adjustable manner such that the pivot portion of the rocker member is configured to move relative to the longitudinal axis of the crankshaft.

47. The internal combustion engine of claim 46, wherein the pivot portion of the rocker member is operably coupled to the cylinder block via a pin.

48. The internal combustion engine of claim 44, wherein the piston is configured to reciprocate within the cylinder between spaced stroke termination points defining a stroke of the piston, and wherein in the second mode, reversal of a direction of travel of the piston within the cylinder is delayed until the radial axis of the crankshaft has rotated at least about 10 degrees past a point corresponding to at least one of the stroke termination points.

49. The internal combustion engine of claim 44, wherein the piston is configured to reciprocate within the cylinder between spaced stroke termination points defining a stroke of the piston, and wherein in the second mode, reversal of a direction of travel of the piston within the cylinder is delayed until the radial axis of the crankshaft has rotated at least about 20 degrees past a point corresponding to at least one of the stroke termination points.

50. The internal combustion engine of claim 44, wherein the piston is configured to reciprocate within the cylinder between spaced stroke termination points defining a stroke of the piston, and wherein in the second mode, reversal of a direction of travel of the piston within the cylinder is delayed until the radial axis of the crankshaft has rotated at least about 30 degrees past a point corresponding to at least one of the stroke termination points.

51. The internal combustion engine of claim 44, wherein the piston is configured to reciprocate within the cylinder between spaced stroke termination points defining a stroke of the piston, and wherein in the second mode, reversal of a direction of travel of the piston within the cylinder is delayed until the radial axis of the crankshaft has rotated at least about 40 degrees past a point corresponding to at least one of the stroke termination points.

52. The internal combustion engine of claim 44, wherein the pivot portion is operably coupled to the cylinder block via a pin.

53. The internal combustion engine of claim 52, wherein the pin is operably coupled to the cylinder block in an adjustable manner such that the pivot portion of the rocker member is configured to move relative to the longitudinal axis of the crankshaft.

54. The internal combustion engine of claim 52, wherein the pivot portion comprises a pivot aperture and the rocker member is operably coupled to the cylinder block via the pin and the pivot aperture.

55. The internal combustion engine of claim 44, wherein the slot of the rocker member comprises a curved portion.

56. The internal combustion engine of claim 44, wherein the slot of the rocker member comprises a straight portion and a curved portion.

57. The internal combustion engine of claim 44, wherein the slot of the rocker member comprises a first straight portion, a curved portion, and a second straight portion.

58. The internal combustion engine of claim 57, wherein the curved portion is between the first straight portion and the second straight portion.

59. The internal combustion engine of claim 44, wherein the coupling portion of the rocker member comprises a recess receiving the proximal end of the connecting rod.

60. The internal combustion engine of claim 59, wherein the recess of the coupling portion comprises an aperture receiving an ankle pin operably coupling the proximal portion of the connecting rod to the rocker member.

61. The internal combustion engine of claim 59, wherein the recess defines a v-shaped clearance.

62. The internal combustion engine of claim 61, wherein the recess of the coupling portion comprises an aperture receiving an ankle pin operably coupling the proximal portion of the connecting rod to the rocker member, and wherein the v-shaped clearance is asymmetrical with respect to the aperture receiving the ankle pin.

63. The internal combustion engine of claim 44, further comprising a bushing on the crankpin.

64. A power train comprising:
the engine according to claim 1;
a transmission operably coupled to the engine; and
a drive member configured to perform work, the drive member being operably coupled to the transmission.

65. The power train of claim 64, wherein the drive member comprises a propulsion device.

66. The power train of claim 65, wherein the propulsion device comprises at least one of a wheel and a propeller.

67. The power train of claim 64, further comprising:
a generator configured to convert rotational power into electrical power, the generator being operably coupled to the engine; and
a power storage device configured to store electrical power, the power storage device being operably coupled to the generator,
wherein the transmission comprises an electric motor.

68. A vehicle comprising:
the engine according to claim 1;
a transmission operably coupled to the engine; and
a drive member configured to perform work, the drive member being operably coupled to the transmission.

69. The vehicle of claim 68, wherein the drive member comprises a propulsion device.

70. The vehicle of claim 69, wherein the propulsion device comprises at least one of a wheel and a propeller.

71. The vehicle of claim 68, further comprising:
a generator configured to convert rotational power into electrical power, the generator being operably coupled to the engine; and
a power storage device configured to store electrical power, the power storage device being operably coupled to the generator,
wherein the transmission comprises an electric motor.

72. The vehicle of claim 68, wherein the vehicle comprises one of a car, van, truck, boat, ship, train, and air vehicle.
